(19) United States
(12) Patent Application Publication
(10) Pub. No.: US 2007/0260534 A1
(43) Pub. Date: Nov. 8, 2007

(54) METHOD AND SYSTEM FOR IMPLEMENTING CHANGES IN A MORTGAGE LOAN INDEX

(76) Inventors: Daniel Park, Chatham, NJ (US); Michael Young, Atlantic Beach, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/381,398

(22) Filed: May 3, 2006

(51) Int. Cl. G06Q 40/00

(52) U.S. Cl. 705/38; 705/36 R

(57) ABSTRACT

The present invention is a mortgage method, product, and system that provides for implementing changes in a mortgage loan index, referred to herein as an Interest Rate Index Swap or “Swap”. Customers may swap from their original adjustable loan index (e.g., 3-month LIBOR) to temporary fixed-rate indexes (e.g., 3-year LIBOR) as many times as they deem appropriate during the Swap Window provided the final swap period ends prior to the end of the Swap Window.

### BACKGROUND OF THE INVENTION

1. Field of the Invention

The present invention is directed to a method and system for controlling financial data, and more specifically to a method and system for implementing changes in a mortgage loan index.

2. Description of the Related Art

Mortgages usually take the form of fixed and/or adjustable rate mortgages. A fixed rate mortgage retains the same rate throughout the lifetime of the mortgage (e.g., 15 or 30 years). On the other hand, adjustable rate mortgages (ARMs) start out at an initial rate and vary over the term of the loan, subject to a fixed maximum and for periodic fixed intervals. A particular index is used to calculate the interest rate on an ARM by adding a fixed margin to the index. An index is a published measure of rate of return of a composite of financial instruments such as Treasury notes or Treasury bills. As such, there are many possible ARM indices. Each one has distinct market characteristics and fluctuates differently. CMT (Constant Maturity Treasury), COFI (Cost of Funds Index), and LIBOR (London Inter Bank Offering Rate) indices are the most frequently used, but there are others.

There are several different rates widely used as ARM indices: 1-, 3-, 6-Month, and 1-Year. For each of these indices, the rate will change based on the time period. For example, the interest rate will adjust every month for a 1 month LIBOR, every 3 months for a 3-month LIBOR, and so on. With respect to the LIBOR index, for example, the 6-Month LIBOR is the most common. As an example, the LIBOR rates for a particular time period may be as follows: 1-month LIBOR—4.6310%, 3-month LIBOR—4.8192%, 6-month LIBOR—4.9907%, 1-year LIBOR—5.1526%. As market conditions change, mortgage rates change as well. In this example, the 1-month LIBOR has the lowest rate. However, that rate will change every month. In some cases it may be better to lock in the rate of a 1-year LIBOR rather than risk the monthly variability of the 1-month LIBOR. Conversely, in some cases a rate locked in for a full year cannot take advantage of falling interest rates.

When rates change, usually a mortgagee can refinance a mortgage by taking a new mortgage at a lower rate and paying off the existing mortgage with the proceeds from the new mortgage. However, refinancing often includes closing costs and “points” paid for creating the new loan. After executing a new mortgage (with its associated refinancing costs), the mortgagee enjoys the benefits of the new rate, until the rates fall yet again and the process must be repeated anew.

A number of patents disclose computer-based methods and systems for mortgage programs, including, U.S. Pat. Nos. 6,904,414, 6,904,412, 6,671,677, 6,269,347, and U.S. Published Application Nos. 2004/0088247, 2002/0046158, 2002/0019805, 2004/0193521, and 2005/0102207; all of which are incorporated herein by reference.

In particular, U.S. Patent Application No. 2002/0046158, published in April 2002, discloses a computer-based method and system for controlling the mortgage rate charged to a mortgagee as a prevailing mortgage rate drops. Using an Automatic Rate Cut (A.R.C.) mortgage, a customer's interest rate may be reduced without going through a traditional refinance process. Once the customer has been in the program for a specified period since settlement date, the interest rate can be modified down provided that interest rates have declined since the customer entered the A.R.C. Loan. Secondary conditions can also be used to determine if the mortgage qualifies for a rate reduction.

U.S. Patent Application No. 2002/0019805, to Kalotay, discloses a method for structuring a mortgage having an associated current interest rate based upon a time-varying market interest rate, whereby as the market interest rate declines with time, the current interest rate for the mortgage declines. When the market interest rate increases with time, the current interest rate remains unchanged. The method includes the steps of: calculating the current interest rate for the mortgage at a first time dependent upon the market interest rate at the first time; and secondly, calculating a reset interest rate for the mortgage at a second time dependent upon the market interest rate at the second time. If the reset rate is less than the current rate, the current rate is reset or updated to the reset rate and the mortgage is operated using the reset current interest rate. If the reset rate is equal to or greater than the current rate, the mortgage is operated using the current interest rate.

### SUMMARY OF THE INVENTION

The present invention is a mortgage method and system that provides for implementing changes in a mortgage loan index, referred to herein as an “Interest Rate Index Swap or Swap.” This method allows a mortgage customer to swap from the “Original Loan Index” (e.g., 1-month, 3-month, 6-month, or 1-year LIBOR) to a fixed “Interest Rate Swap Index or Swap Index” (and margin) for an “Interest Rate Index Swap Period or Swap Period” (e.g., 2, 3, 4 or 5 year LIBOR) without having to refinance. At the end of the Swap Period, the loan will revert back to its Original Loan Index (and margin), unless another swap is exercised.

The Interest Rate Index Swap may be exercised one or more times during a specified period of the loan (i.e., the Swap Window), such as during the adjustable rate interest only period of the loan. For example, in a 30 year term mortgage, the loan has a 15 year interest only adjustable period (Interest Only Period) which could equate to the “Swap Window” followed by a conversion to a 15 year fully amortized period (Amortization Period)). In certain situations, a Breakage fee may be applied in accordance with specific rules. The Swap Window could be set to any portion of the loan term and would not necessarily have to associate directly with the interest only period.

(1) In an embodiment of the invention, the method comprises the steps of initiating a loan based on Original Loan Index (OLI) having an adjustable OLI rate, OLI period, and OLI margin, and having a loan term with a Swap Window;

(2) until the Swap Window expires, at the end of each OLI period or Swap period, optionally

(a) exercising one of a plurality of available Interest Rate Index Swaps having a fixed swap rate, swap period and swap margin, or

(b) continuing the loan with the Original Loan Index after adjusting to the current adjustable OLI rate, OLI period and OLI margin;

(3) upon expiration of the Swap Window, continuing the loan with the Original Loan Index after adjusting to the current adjustable OLI rate, OLI period and OLI margin for the remainder of the loan term

The method further includes the step of instituting a penalty should a Swap Period be terminated early, such as when another one of a plurality of available Interest Rate Index Swaps having a fixed swap rate, swap period and swap margin is exercised prior to the end of the Swap Period. The penalty may be in the form of a Breakage Fee.

The Swap Window preferably comprises a window of time between the end of the initial OLI period and the end of a predetermined period, often the Interest Only Period of an Adjustable Interest Only Loan that becomes an Amortized Loan after the Interest Only Period. For example, a Loan could have a term of 30 years with an initial 15-year Swap Window followed by a 15-year period where the Swap is no longer available.

The Original Loan Index is preferably selected from one of the following LIBOR indices: 1-month, 3-month, 6-month, or 1-year LIBOR. The Interest Rate Index Swap (Swap Index) is preferably selected from one of the following fixed LIBOR indices: 2-year, 3-year, or 5-year LIBOR. The Swap Window limits the Swap Indices available for selection in order that that the swap period will not end after the Swap Window. Alternately, other indices/periods/margins/terms/windows may be used.

The method may also be described as a method for changing an Original Loan Index of a loan for a limited period of time during the term of the loan, comprising: (a) providing a window of time during the term of the loan; (b) during said window of time, optionally adjusting the loan index one or more times to a fixed rate loan index for a limited period, wherein for any time not within the limited period, the loan reverts to the Original Loan Index; (c) upon expiration of the window of time, continuing the loan with the Original Loan Index for the remainder of the loan term.

In addition to the method noted above, the invention can also be implemented as a mortgage product, a financial product, a computer program product, or a computer system. As a computer system, an embodiment of the invention includes a data source containing data, a display device and a processor unit. The processor unit operates to access the data source to retrieve the data, operate on the data, and then display the retrieved data in the display areas as part of the Interest Rate Index Swap. As a computer program product containing program instructions for displaying data on a display device of a computer system, the data being obtained from a data source, an embodiment of the invention includes computer readable code devices for implementing the method of the invention.

Specifically, an embodiment of the invention comprises a mortgage product for a loan having a mortgage term component defining the length of the loan; an Original Loan Index (OLI) component providing terms and conditions for an adjustable OLI rate and corresponding OLI period applied to the mortgage term; and a swap component providing a plurality of Swap Indices, each providing terms and conditions for a fixed swap rate and corresponding fixed swap period, wherein the swap component is substituted for the Original Loan Index one or more times during a swap window of time during the mortgage term.

Another embodiment of the invention comprises a financial product for a loan having means for establishing a window of time during the term of the loan, said loan based on an Original Loan Index (OLI) providing terms and conditions for an adjustable OLI rate and corresponding OLI period applied to the term; means for optionally changing the loan index one or more times, during said window of time, to a fixed rate loan index for a fixed period, wherein for any time not within the fixed period, the loan reverts to the Original Loan Index; and means for continuing the loan with the Original Loan Index for the remainder of the loan term upon expiration of the window of time.

As a computer program product, an embodiment of the invention includes a computer storage medium and a computer program code mechanism embedded in the computer storage medium for causing the computer to control the Index associated with a mortgage, the computer program code mechanism comprising: a first computer code device configured to establish a window of time during the term of the loan, said loan based on an Original Loan Index (OLI) providing terms and conditions for an adjustable OLI rate and corresponding OLI period applied to the term; a second computer code device configured to optionally change the loan index one or more times, during said window of time, to a fixed rate loan index for a fixed period, wherein for any time not within the fixed period, the loan reverts to the Original Loan Index; and a third computer code device configured to continue the loan with the Original Loan Index for the remainder of the loan term upon expiration of the window of time.

The invention also comprises a mortgage created according to the steps of: (a) initiating a loan having an Original Loan Index (OLI) with an OLI rate and OLI period, said loan having a Swap Window defined within the term; (b) until the Swap Window expires, at the end of each OLI period or swap period, optionally (i) changing the index of the loan to one of a plurality of available swap rates and swap periods, or (ii) continuing the loan with the Original Loan Index; and (c) upon expiration of the Swap Window, continuing the loan with the Original Loan Index for the remainder of the loan term.

Accordingly, it is an object of the invention to provide a mortgage method and system that will allow loan customers to fix the rate of their mortgage loan for one or more specified Interest Rate Index Swap periods during the Swap Window without having to refinance.

It is another object of the invention to provide a mortgage method and system that allows exercising the Swap as many times as they deem appropriate during a specified period of the loan.

These and other objects of the present invention will become readily apparent upon further review of the following specification and drawings.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of a computer system for implementing a method of the invention in an embodiment;

FIG. 2 is a flowchart showing a method of exercising the Interest Rate Index Swap according to one embodiment of the present invention;

FIG. 3 is a flowchart showing a method of exercising the Interest Rate Index Swap with specific numerical examples according to another embodiment of the present invention;

It should be understood that in certain situations for reasons of computational efficiency or ease of maintenance, the ordering of the blocks of the illustrated flow charts could be rearranged or moved inside or outside of the illustrated loops by one skilled in the art.

### DETAILED DESCRIPTION OF THE PREFERRED EMBODIMENTS

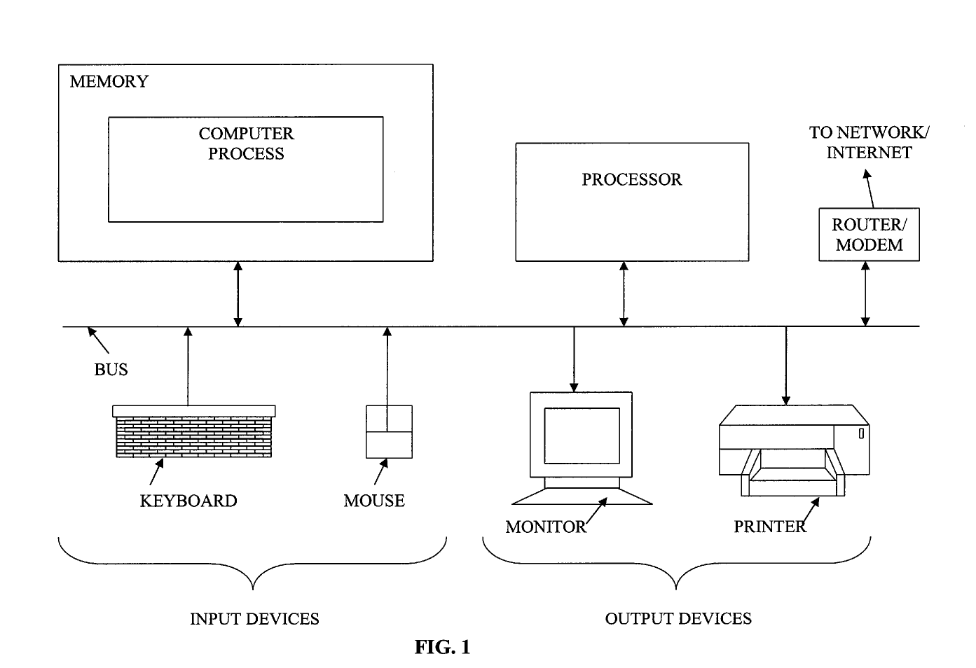

The present invention is a mortgage method and system that provides for implementing changes in a mortgage loan index, referred to herein as an Interest Rate Index Swap or “Swap”. The method may be computer based and implemented on a computing system, such as that shown in FIG. 1. Any of a number of computing arrangements capable of implementing the present method may also be utilized, as known in the art.

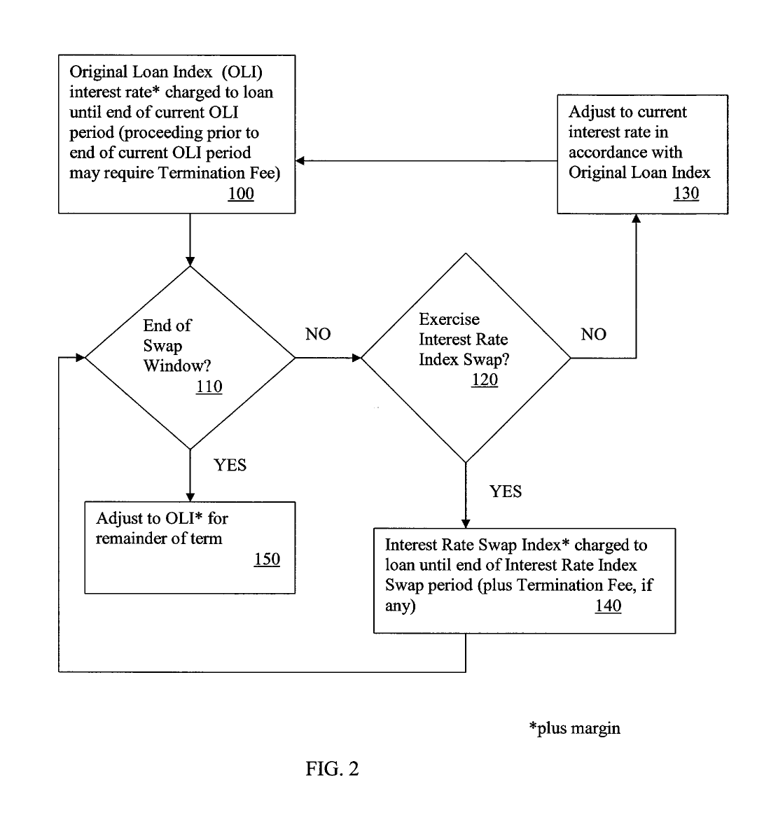

Turning now to FIG. 2, an embodiment of the invention is shown as a flowchart representing steps of an embodiment of the method. Initially, as shown in box 100 a customer is issued a loan having an Original Loan Index with a particular OLI interest rate, OLI margin, and OLI period (e.g., 1-month, 3-month, 6-month, or 1-year LIBOR). The end of the OLI period is the rate change date. The loan itself has a predetermined Swap Window. In this example, the Swap Window is the Interest Only Period. The Interest Only Period is followed by the Amortization Period, which is outside the Swap Window. At the end of the OLI period, in decision box 110, it is determined whether the loan term has reached the end of the Interest Only Period/Swap Window. If so, the loan proceeds to the Amortization Period for the remainder of the term in box 150, with the original OLI loan terms (or other previously determined loan terms for the Amortization period). If not, the customer may choose to exercise the Interest Rate Index Swap (the “Swap”) in decision box 120. If the Swap is not exercised, then the current interest rate of the loan is adjusted in accordance with the Original Loan Index in box 130 and the method returns to box 100 (the same as a standard ARM, where at the end of the OLI period, the interest rate will change).

If, on the other hand, the customer chooses to exercise the Swap in decision box 120, then an available Interest Rate Swap Index is selected in box 140 and used for the loan until the end of the Swap period. At the end of the Swap period, the method again returns to decision box 110 (End of Swap Window) and, if not, then proceeds to the decision box 120 as before. This allows the customer to exercise the Swap multiple times as long as the customer has not reached the end of the Swap Window period.

To exercise the Swap, generally a customer would make the decision to Swap in advance of the rate change date to provide time to implement the Swap. In an embodiment, the customer would preferably contact Loan Servicing within a certain notification window prior to the rate change date on which they want the Swap to go into effect to provide advance notice. Other forms of notice are also contemplated herein, including an automatic notification (to or from the customer) when rates reach a certain threshold. Then, the Swap would be timely exercised on the rate change date. In an alternate embodiment, should the mortgage system support it, the decision to Swap could be made at any time prior to the rate change date, including on the rate change date itself. However, since interest rates are constantly changing, the time period in which to make the decision to Swap may be limited to a specific notification window.

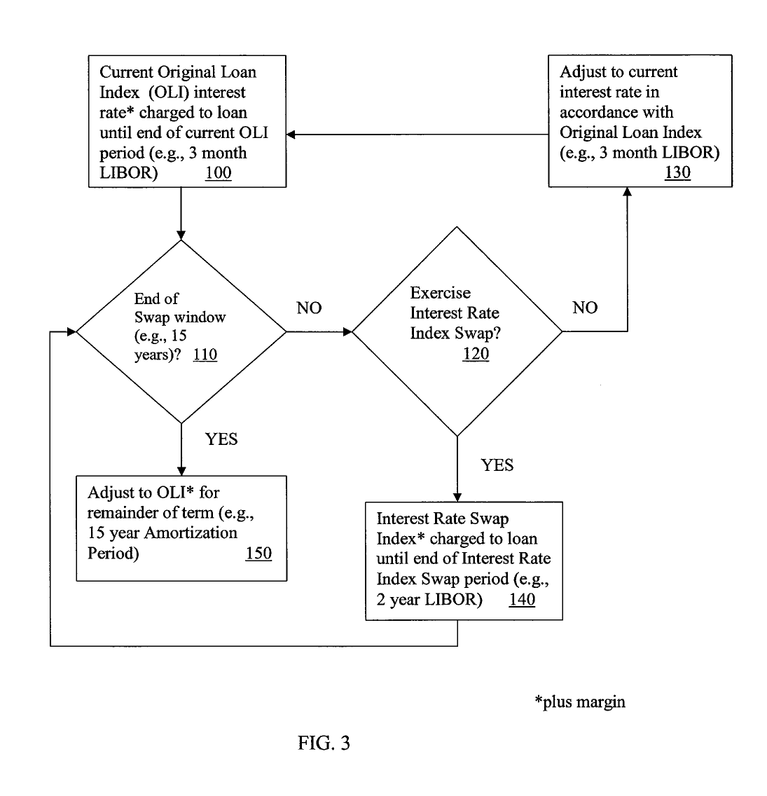

FIG. 3 shows a flowchart that includes numerical examples for the method. In this Example, the loan starts as a 3-month LIBOR, box 100. When the customer exercises the Swap, box 120, the loan becomes a 2-year LIBOR, box 140. Depending on the choices in the decision boxes (110, 120), the customer may exercise this Swap multiple times until the end of the Swap Window. The available Swap Indices will depend on the time remaining in the Swap Window, as discussed in more detail hereafter.

Specifically, since the Swap may be exercised one or more times during the Swap Window, it is important that the end date of any Swap period not interfere with the date for the Amortization Period (non-Swap period). Thus, as part of the Swap method, only the Swap Indices that do not interfere with the date for the Amortization Period will be available for selection. For example, if there is only 2 years remaining in the Swap Window, a 3-year or 5-year Swap Index will not be available for that customer (only a 2-year Swap will be available based on the availability dates). For a 30-year term loan with a 15-year adjustable period, the “Swap Window” would end at the 180^{th} payment. Any Swap Indices exercised must, therefore, end before or on the 180^{th} payment. The payment number for which the Swap Window would begin depends on the Original Loan Index. For example, in a 6 month LIBOR Original Loan Index, the Swap Window would not begin until the 6^{th} payment (i.e., the end of the OLI period).

Table 1 demonstrates the availability dates by Original Loan Index and Swap Index for Original Loan Indices of 1-month, 3-month, 6-month, or 1-year LIBOR and Swap Indices of 2, 3, 4 or 5 year LIBOR.

TABLE 1
Availability Dates

| | Swap | 30-Year Term |
|---|---|---|
| Initial Index | Index | Available Between Payments |
| 1 Month LIBOR | 2-Year | 2 and 156 |
| | 3-Year | 2 and 144 |
| | 4-Year | 2 and 132 |
| | 5-Year | 2 and 120 |
| 3 Month LIBOR | 2-Year | 3 and 156 |
| | 3-Year | 3 and 144 |
| | 4-Year | 3 and 132 |
| | 5-Year | 3 and 120 |
| 6 Month LIBOR | 2-Year | 6 and 156 |
| | 3-Year | 6 and 144 |
| | 4-Year | 6 and 132 |
| | 5-Year | 6 and 120 |
| 1 Year LIBOR | 2-Year | 12 and 156 |
| | 3-Year | 12 and 144 |
| | 4-Year | 12 and 132 |
| | 5-Year | 12 and 120 |

Original Loan Indices and Swap Indices other than those illustrated in Table 1 may be used as known in the art, provided the Swap is exercised and ends within the Swap Window. Accordingly, this method allows a mortgage customer to swap from the Original Loan Index (e.g., 1-month, 3-month, 6-month, or 1-year LIBOR) to a fixed Interest Rate Swap Index (and margin) for the Swap period (e.g., 2, 3, 4 or 5 year LIBOR) without having to refinance. At the end of the Swap period, the loan will revert back to its Original Loan Index (and margin), unless the Swap is exercised again.

If a customer wishes to terminate the Swap before the end of the Swap period, a procedure is provided for early termination. In some cases, an early Swap termination may result in a penalty, such as a fee. Preferably, no Breakage fees would be required while the loan is in its adjustable-rate period based on an Original Loan Index. However, there is the potential of a Breakage fee during a Swap (e.g., a fixed-rate period when the Swap has been exercised). Normally no Breakage fee would be required if the customer terminates and becomes subject to a higher interest rate. However, a Breakage fee/penalty may be required if the customer terminates to benefit from a lower interest rate Swap Index.

Following are examples that illustrate procedures for practicing the invention. These examples should not be construed as limiting.

### EXAMPLE 1

### Notification Window for Swap

Example:

| | | |
|---|---|---|
| Client closes | November 200X | First payment due |
| mortgage loan | | January 1, 200X |
| Client decides to | Payment 84 | Due January 01, |
| swap to 3-year | | 200(X + 7) |
| Interest Rate Swap | | |
| Index in year | | |
| seven of loan | | |
| | Rate change date | December 01, |
| | for payment 84 | 200(X + 6) |
| | (first business | |
| | day of the month | |
| | prior to payment | |
| | change date) | |
| Client to notify | No later than one | Notification |
| Loan Servicing | week prior to rate | date cutoff |
| | change date | November 22, |
| | | 200X + 6) |

This example demonstrates the preferred notification cutoff for exercising a swap in year seven of a loan (Payment 84).

### EXAMPLE 2

### Six-Month LIBOR Swap to 3-Year Fixed LIBOR

Example:

| | | |
|---|---|---|
| Client closes | November 200X | First payment due |
| mortgage loan | | January 1, 200X |
| Clients rate at | Six-month LIBOR | 4.625% |
| closing | (3.0%) + margin | |
| | (1.625%) | |
| Client decides to | On rate change | 3-year LIBOR |
| swap to 3-year | date | index = 4% |
| fixed rate in year | (December 01, | |
| seven and notifies | 200(X + 6) | |
| loan servicing | | |
| Clients 3-year | 4% + 1.625% | 3-Year fixed-rate = |
| fixed rate | (loan margin) | 5.625% which will be |
| | | in place until |
| | | January 01, 200(X + 10) |

In this example, using specific dates, the customer swaps from a six-month LIBOR at 3% to a 3-year LIBOR at a 4% rate in year seven of the loan. The swap period would end 3 years after the change date.

### EXAMPLE 3

### Early Termination of Swap for Refinance at a Higher Rate

Example:

| | | |
|---|---|---|
| Client swaps to | Client decides | |
| 3-year LIBOR | to refinance on | |
| Swap index at | January 1, | |
| 4% on January 1, | 200(X + 8) | |
| 200(X + 6) | | |
| 3-year LIBOR | 3-year LIBOR | Initial Swap Index |
| Swap Index on | Swap Index on | rate (4.0%-4.5%) |
| refinance date | initial Swap | 3-year LIBOR Swap |
| (Jan. 01, | Index Rate | Index on refinance |
| 200X + 8) = 4.5% | determination | date = +.50 |
| | date (Nov. 01, | *Since the Swap Index |
| | 200X + 6) = | Rate increased no |
| | 4.0% | Breakage Fee is |
| | | required |

In this example, using specific dates, the customer swaps to a 3-year LIBOR at a 4% rate on Jan. 1, 2000. The swap period would normally end on Jan. 1, 2003. However, the customer decides to terminate the swap one year early (Jan. 1, 2002) to refinance to another Swap Index. The customer's new Swap Index is a 3-year LIBOR at a 4.5% rate beginning on the refinance date of Jan. 1, 2002 and now ending on Jan. 1, 2005. The rate increased by 0.5% in the new Swap Index. In this instance, normally no Breakage fee would be required since the customer is now subject to a higher interest rate.

### EXAMPLE 4

### Early Termination of Swap for Refinance at a Lower Rate with Penalty

Example:

| Client swaps to | Client decides | |
|---|---|---|
| 3-year LIBOR | to refinance | |
| Swap index at | home on | |
| 4% on January 1, | January 1, | |
| 200(X + 6) | 200(X + 8) | |
| 3-year LIBOR | 3-year LIBOR | Initial Swap Index |
| Swap Index on | Swap Index on | (4.0%-3.5%) 3-year |
| refinance date | initial Swap | LIBOR Swap Index on |
| (Jan. 01, | Index Rate | refinance date = −.50 |
| 200X + 8) = 3.5% | determination | *Since the Swap Index |
| | date (Nov. 01, | Rate decreased a |
| | 200X + 6) = | Breakage Fee is |
| | 4.0% | required |

In this example, using specific dates, the customer swaps to a 3-year LIBOR at a 4% rate on Jan. 1, 2000. The swap period would normally end on Dec. 31, 2002. However, the customer decides to terminate the swap one year early (Jan. 1, 2002) to refinance to another Swap Index. The customer's new Swap Index is a 3-year LIBOR at a 3.5% rate beginning on the refinance date of Jan. 1, 2002 and now ending on Dec. 31, 2004. The rate decreased by 0.5% in the new Swap Index. In this instance, normally a Breakage fee/penalty would be required since the customer now benefits from a lower interest rate.

The penalty may take a number of forms. During the Swap period the potential for a “Breakage Fee” becomes effective. Generally, the Breakage Fee would only be applicable during the Swap period and ends when the loan reverts back to the original index+margin ARM. The Swap period Breakage Fee does not need to be a set amount. Instead, preferably it is a factor of the change (reduction) in the Swap Index rate during the Swap period. If the Swap Index rate increases or does not change during the Swap period, usually there is no Breakage Fee. The potential Breakage Fee could be required whenever principal reduction payments are received or if the client chooses to terminate the Index Swap early. In an example, it may be calculated as in Example 5, below:

### EXAMPLE 5

### Calculating Breakage Fee

The Breakage Fee required would be determined by:

Multiply the negative Swap Index differential by the outstanding loan balance.

Divide by 365 (the number of days in a year to determine the daily rate of the Breakage Fee).

Multiply the number of days remaining in the Swap period (In the example above there would be 365 days remaining in the Swap Period).

| Loan amount × | Swap Index | Breakage Fee daily |
|---|---|---|
| Swap Index | differential/ | rate × number of |
| differential | 365 days = | days remaining in |
| | daily rate of | Swap Period = |
| | Breakage Fee | Breakage Fee Amount |
| $400,000 × | $2,000/ | $5.48 × 365 |
| .50% = $2,000 | 365 = $5.48 | days = $2,000 |

### EXAMPLE 6

### Loan Terms/Rates

The following is an example of terms/rates that might be used for the Swap of the present invention.

OLI and Term

Product Description

1 Month LIBOR ARM - 30 Year Term (15 Year Interest Only/15 Year
Fully Amortized)
3 Month LIBOR ARM - 30 Year Term (15 Year Interest Only/15 Year
Fully Amortized)
6 Month LIBOR ARM - 30 Year Term (15 Year Interest Only/15 Year
Fully Amortized)
1 Year LIBOR ARM - 30 Year Term (15 Year Interest Only/15 Year
Fully Amortized)

ARM Information

| | | | | Interest Rate |
|---|---|---|---|---|
| | | | Periodic | Index Swap |
| Product | Index | Margin | Adjustment | Feature |
| 1 Month | 1 Month | ⁽¹⁾ | The interest rate | Available |
| | LIBOR ⁽²⁾ | | will adjust every | |
| | | | month, beginning | |
| | | | with the second | |
| | | | monthly payment | |
| 3 Month | 3 Month | | The interest rate | Available |
| | LIBOR ⁽³⁾ | | will adjust every | |
| | | | three months. | |
| 6 Month | 6 Month | | The interest rate | Available |
| | LIBOR ⁽³⁾ | | will adjust every | |
| | | | six months. | |
| 1 Year | 1 Year | | The interest rate | Available |
| | LIBOR ⁽³⁾ | | will adjust every | |
| | | | year. | |

⁽¹⁾ Margin is subject to change. It is a component of pricing and will vary based on the rate/point combination selected.
⁽²⁾ 1 Month Index Established Date = 25 days prior to change date.
⁽³⁾ 3 and 6 Month and 1 Year Indexes Established Date = 1^{st} business day of the month prior to change date.

Rate Caps

The loan is subject to interest rate adjustments (up or down). The adjusted interest rate may never be greater than the note rate +5%, or 12% whichever is greater.

Initial and periodic adjustments are not capped and will move in accordance with the market as long as the adjustments do not exceed the lifetime cap.

The loan can never adjust lower than the margin.

Interest-Rate Index Swap Example Features

The Swap feature allows clients to swap from the original mortgage loan index (1-Month, 3-Month, 6-Month or 1-Year LIBOR) to the 2-Year, 3-Year, 4-Year, or 5-Year LIBOR Interest Rate Swap index during the Swap Window (e.g., 15-year interest-only period of the loan). The benefit of this feature is that it provides clients the ability to fix the rate of their mortgage loan for a Swap Period (e.g., 5 years) without having to refinance. At the end of the Swap period the loan will revert back to its original index and margin.

May be used with any index (e.g., 1-Month, 3-Month, 6-Month or 1-Year LIBOR).

Available during the predefined Swap Window (e.g., starting on the first payment change date through the date within the Interest-Only period which would allow the Interest Rate Index Swap term to expire prior to conversion to the Amortization Period).

If clients exercise the Index Swap Feature the potential for a Breakage Fee goes into effect.

Clients may cancel or terminate the Swap at any time during the Swap period but they may be required to pay a Breakage fee to do so.

Clients may fix as many times as they deem appropriate during the Swap Window (e.g., 15-year interest-only period) provided the final Swap Period (e.g., fixed rate period) ends prior to the end of the Swap Window (e.g., the end of the initial amortized payment—which in this example, all swap periods (fixed rate periods) will end by payment 180).

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other means by which a human can input data into a computer, including through other programs such as application programs.

It should be understood that the examples and embodiments described herein are for illustrative purposes only and that various modifications or changes in light thereof will be suggested to persons skilled in the art and are to be included within the spirit and purview of this application.

1. A method for changing the index of a loan for a limited period of time during the term of the loan, comprising:
(a) initiating a loan having an Original Loan Index (OLI) with an OLI rate and OLI period, said loan having a Swap Window defined within the term;
(b) until the Swap Window expires, at the end of each OLI period or swap period, optionally
(i) changing the index of the loan to one of a plurality of available swap rates and swap periods, or
(ii) continuing the loan with the Original Loan Index;
(c) upon expiration of the Swap Window, continuing the loan with the Original Loan Index for the remainder of the loan term.

2. The method of claim 1 wherein step (b)(ii) of continuing the loan with the Original Loan Index further comprises adjusting to the current adjustable OLI rate.

3. The method of claim 1 wherein step (c) of continuing the loan with the Original Loan Index further comprises adjusting to the current adjustable OLI rate.

4. The method of claim 1 wherein the Swap Window is available during an Interest Only Period of the loan.

5. The method of claim 4 wherein the Swap Window begins at the end of the first OLI period.

6. The method of claim 1 wherein the OLI rate is adjustable.

7. The method of claim 1 wherein swap rate is fixed.

8. The method of claim 1, further comprising a margin added to the OLI rate and the Swap rate.

9. The method of claim 1, further comprising imposing a penalty if the index of the loan is changed prior to the end of a current swap period to one of a plurality of available swap rates having a lower interest rate.

10. A method for changing an Original Loan Index of a loan for a limited period of time during the term of the loan, comprising:
(a) providing a window of time during the term of the loan;
(b) during said window of time, optionally adjusting the loan index one or more times to a fixed rate loan index for a limited period, wherein for any time not within the limited period, the loan reverts to the Original Loan Index;
(c) upon expiration of the window of time, continuing the loan with the Original Loan Index for the remainder of the loan term.

11. A mortgage product for a loan comprising:
a mortgage term component defining the length of the loan;
an Original Loan Index (OLI) component providing terms and conditions for an adjustable OLI rate and corresponding OLI period applied to the mortgage term;
a swap component providing a plurality of Swap Indexes, each providing terms and conditions for a fixed swap rate and corresponding fixed swap period, wherein the swap component is substituted for the Original Loan Index one or more times during a swap window of time during the mortgage term.

12. A financial product for a loan comprising:
means for establishing a window of time during the term of the loan, said loan based on an Original Loan Index (OLI) providing terms and conditions for an adjustable OLI rate and corresponding OLI period applied to the term;
means for optionally changing the loan index one or more times, during said window of time, to a fixed rate loan index for a fixed period, wherein for any time not within the fixed period, the loan reverts to the Original Loan Index;
means for continuing the loan with the Original Loan Index for the remainder of the loan term upon expiration of the window of time.

13. A computer program product, comprising:
a computer storage medium and a computer program code mechanism embedded in the computer storage medium for causing the computer to control the Index associated with a mortgage, the computer program code mechanism comprising:
a first computer code device configured to establish a window of time during the term of the loan, said loan based on an Original Loan Index (OLI) providing terms and conditions for an adjustable OLI rate and corresponding OLI period applied to the term;
a second computer code device configured to optionally change the loan index one or more times, during said window of time, to a fixed rate loan index for a fixed period, wherein for any time not within the fixed period, the loan reverts to the Original Loan Index
a third computer code device configured to continue the loan with the Original Loan Index for the remainder of the loan term upon expiration of the window of time.

14. A mortgage created according to the steps of: (a) initiating a loan having an Original Loan Index (OLI) with an OLI rate and OLI period, said loan having a Swap Window defined within the term; (b) until the Swap Window expires, at the end of each OLI period or swap period, optionally (i) changing the index of the loan to one of a plurality of available swap rates and swap periods, or (ii) continuing the loan with the Original Loan Index; and (c) upon expiration of the Swap Window, continuing the loan with the Original Loan Index for the remainder of the loan term.
